(19) United States
(12) Patent Application Publication
(10) Pub. No.: US 2026/0320451 A1
(43) Pub. Date: Oct. 15, 2026

(54) METHOD AND DEVICE FOR LOW-LATENCY EVENT PROCESSING

(71) Applicants: Commissariat à l'Energie Atomique et aux Energies Alternatives, Paris (FR); PROPHESEE, Paris (FR)

(72) Inventors: Thomas DALGATY, Grenbole (FR); Thomas MESQUIDA, Grenoble (FR); Damien JOUBERT, Le Plesis Robinson (FR); Christoph POSCH, Bad Fischau (AT)

(21) Appl. No.: 19/485,370

(22) PCT Filed: May 30, 2024
(86) PCT No.: PCT/EP2024/064926

§ 371 Date: Nov. 18, 2025

(30) Foreign Application Priority Data
May 30, 2023 (FR) 2305360

(51) Int. Cl. G06N 5/046

(52) U.S. Cl. CPC G06N 5/046

(57) ABSTRACT

The present disclosure relates to a method of generating, by a data processing device, a prediction based on event data captured by an event-based sensor, the method comprising: receiving, from the event-based sensor, a new event (e₁) comprising a time stamp and an event data value having one or more dimensions; determining past events falling within a time distance (rₜ) with respect to the time stamp and within a data value distance (r_{xy}) of the event data value; constructing an event sub-graph comprising a first node representing the new event (eᵢ), further nodes representing each of the determined past events, and unidirectional edges linking each further node to the first node; calculating node embeddings for the first node based on edges consisting only of said unidirectional edges; and generating the prediction by applying a function to the node embeddings.

This application claims the priority benefit of French patent application number FR2305360, filed on May 30, 2023, entitled “Method and device for low-latency event processing”, which is hereby incorporated by reference to the maximum extent allowable by law.

### TECHNICAL FIELD

The present disclosure relates generally to the field of data processors and methods of data processing, and in particular to a data processor for processing event-based data generated by an event-based sensor.

### BACKGROUND ART

Event-based sensors are used for various applications, and are particularly adapted to environments where the input data is sparse. Indeed, an event-based sensor provides significant power saving in such environments when compared to a synchronous sensor that samples input data periodically, even when there is no significant input signal. Furthermore, event-based sensors permit a high data compression rate.

For example, event-cameras are different from regular frame-based cameras in that, instead of each pixel periodically integrating charge and recording a light intensity, event-pixels generate binary events in an asynchronous fashion upon light intensity changes. This allows for a massive compression of the information pertaining to movement within a scene. The same principle can be applied to other sensing modalities too—for example, event-based audio.

While convolutional neural networks (CNNs) and, more recently, vision transformers, offer an excellent means of solving computer vision tasks based on frames, they are not naturally compatible with event-data. In order to process event data using such models, events are often integrated into so-called dense-frames by, for example, counting the number of events generated per pixel within a given time window. However, this does not allow the sparse nature and low-latency of event data to be leveraged. Furthermore, while these approaches allow existing CNN architectures, and their optimized hardware implementations, to be reused, the fine spatiotemporal detail captured by event cameras is effectively discarded. This can lead to a performance degradation, particularly for applications such as optical flow prediction. Furthermore, dense-frame CNNs do not readily leverage the inherent sparsity of event-data to reduce computational requirements.

It has been proposed to use graph neural networks in order to process asynchronous event data. One such example is the publication by Schaefer, Simon, Daniel Gehrig, and Davide Scaramuzza entitled “AEGNN: Asynchronous Event-based Graph Neural Networks.” Proceedings of the IEEE/CVF Conference on Computer Vision and Pattern Recognition, 2022. However, a technical difficulty with this solution is that the graph generation is relatively slow, leading to a relatively high latency.

There is need in the art for an improved device and method capable of processing event data in real-time or near real-time to enable processing tightly coupled with the event-sensor.

### SUMMARY OF INVENTION

According to one embodiment, there is provided a method of generating, by a data processing device, a prediction based on event data captured by an event-based sensor, the method comprising: receiving, by the data processing device, a new event from the event-based sensor, the new event comprising a time stamp and an event data value having one or more dimensions; determining, by the data processing device within a list of past events, those past events falling within a time distance with respect to the time stamp and within a data value distance of the event data value; constructing, by the data processing device, an event sub-graph comprising a first node representing the new event, further nodes representing each of the determined past events, and unidirectional edges linking each further node to the first node; calculating, by the data processing device, node embeddings for the first node based on edges consisting of only said unidirectional edges linking each further node to the first node; and generating the prediction by applying a function to the node embeddings.

According to one embodiment, the method further comprises controlling one or more actuators based on the prediction.

According to one embodiment, constructing unidirectional edges linking each further node to the first node comprises constructing unidirectional edges pointing forwards in time, i.e. pointing to/towards the future, linking each further node to a corresponding input of the first node.

According to one embodiment, determining the past events further comprises selecting only M past events to form the determined past events, wherein M is an integer equal to at least two, and constructing the event sub-graph comprises creating only M unidirectional edges linking each further node to the first node, wherein the M past events are for example selected randomly or are selected to be the M past events closest to the new event.

According to one embodiment, determining the past events comprises performing a K-nearest neighbors event search within a past search volume having an event data value radius in the one or more dimensions of the event data value, and a time radius in the time domain.

According to one embodiment, the event-based sensor is an event-camera, and the prediction is an optical flow prediction.

According to one embodiment, the data processing device is configured to perform real-time processing of the new event, the data processing device for example being configured to generate the prediction within a processing delay of less than 100 microseconds, and preferably of less than 5 microseconds, following a time of the new event.

According to one embodiment, generating the prediction comprises passing the event sub-graph through a graph neural network.

According to one embodiment, the graph neural network comprises a plurality of layers, and passing the event sub-graph through the graph neural network comprises: calculating an embedding vector for the first node and for the further nodes of the sub-graph using the embeddings of all events connected by said unidirectional edges, the embedding vector comprising a sub-vector for each of said layers; and applying a transformation to the embedding vector of each node, or to the input event data in the case of a first layer of the graph neural network, in order to generate a resulting embedding vector.

According to a further aspect, there is provided a data processing device for generating a prediction based on event data captured by an event-based sensor, the data processing device being configured to: receive a new event from the event-based sensor, the new event comprising a time stamp and an event data value having one or more dimensions; determine, within a list of past events, those past events falling within a time distance with respect to the time stamp and within a data value distance of the event data value; construct an event sub-graph comprising a first node representing the new event, further nodes representing each of the determined past events, and unidirectional edges linking each further node to the first node; calculate node embeddings for the first node based on edges consisting only of said unidirectional edges linking each further node to the first node; and generate the prediction by applying a function) to the node embeddings.

According to one embodiment, the data processing device is further configured to control one or more actuators based on the prediction.

According to one embodiment, constructing unidirectional edges linking each further node to the first node comprises constructing unidirectional edges pointing forwards in time, i.e. pointing to/towards the future, linking each further node to a corresponding input of the first node.

According to one embodiment, determining the past events further comprises selecting only M past events to form the determined past events, wherein M is an integer equal to at least two, and constructing the event sub-graph comprises creating only M unidirectional edges linking each further node to the first node, wherein the M past events are for example selected randomly or are selected to be the M past events closest to the new event.

According to one embodiment, the data processing device is configured to determine said past events by performing a K-nearest neighbors event search within a past search volume having an event data value radius in the one or more dimensions of the event data value, and a time radius in the time domain.

According to one embodiment, the event-based sensor is an event-camera, and the prediction is an optical flow prediction.

According to one embodiment, the data processing device is configured to perform real-time processing of the new event, the data processing device for example being configured to generate the prediction within a processing delay of less than 100 microseconds, and preferably of less than five microseconds, following a time of the new event.

According to one embodiment, the data processing device is configured to generate the prediction by passing the event sub-graph through a graph neural network.

According to one embodiment, the graph neural network comprises a plurality of layers, and passing the event sub-graph through the graph neural network comprises: calculating, by the graph neural network, an embedding vector for the first node and for the further nodes of the sub-graph using the embeddings of all events connected by said unidirectional edges, the embedding vector comprising a sub-vector for each of said layers; and applying, by the graph neural network, a transformation to the embedding vector of each node, or to the input event data in the case of a first layer of the graph neural network, in order to generate a resulting embedding vector.

According to yet a further embodiment, there is provided a control system comprising: the above data processing device; an event-based sensor coupled to the data processing device and configured to generate the new event and to transmit the new event to the data processing device; and the one or more actuators.

### BRIEF DESCRIPTION OF DRAWINGS

The foregoing features and advantages, as well as others, will be described in detail in the following description of specific embodiments given by way of illustration and not limitation with reference to the accompanying drawings, in which:

FIG. 1 schematically illustrates an event-based sensing and processing system according to an example embodiment of the present disclosure;

FIG. 2 schematically illustrates an event processing device of FIG. 1 in more detail according to an example embodiment of the present disclosure;

FIG. 3 is a graph illustrating an example of the event cloud generated from an event camera recording;

FIG. 4 is a graph illustrating an example of event graph creation based on k-hops between indirectly connected events;

FIG. 5 is a flow diagram illustrating an example of operations in a method of determining an optical flow prediction;

FIG. 6 is a graph illustrating an example of event graph creation according to an example embodiment of the present disclosure;

FIG. 7 is a flow diagram illustrating an example of operations in a method of determining an optical flow prediction according to an embodiment of the present disclosure;

FIGS. 8A and 8B illustrate an example of updating an event graph upon arrival of a new event;

FIGS. 9A and 9B illustrate updating an event graph upon arrival of a new event according to an embodiment of the present disclosure;

FIG. 10 illustrates the generation of an embedding vector in each layer of an event graph according to an example embodiment of the present disclosure;

FIG. 11 illustrates the concatenation of embedding vectors and their application to a neural network; and

FIG. 12 schematically illustrates a neural network head for making a prediction according to an example embodiment of the present disclosure.

### DESCRIPTION OF EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail. In particular, devices and methods for event-based sensing are known in the art and have not been described in detail. Furthermore, the training of a graph neural network, and the use a graph neural network to generate an event-based prediction or detection is well known by those skilled in the art and will not be described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

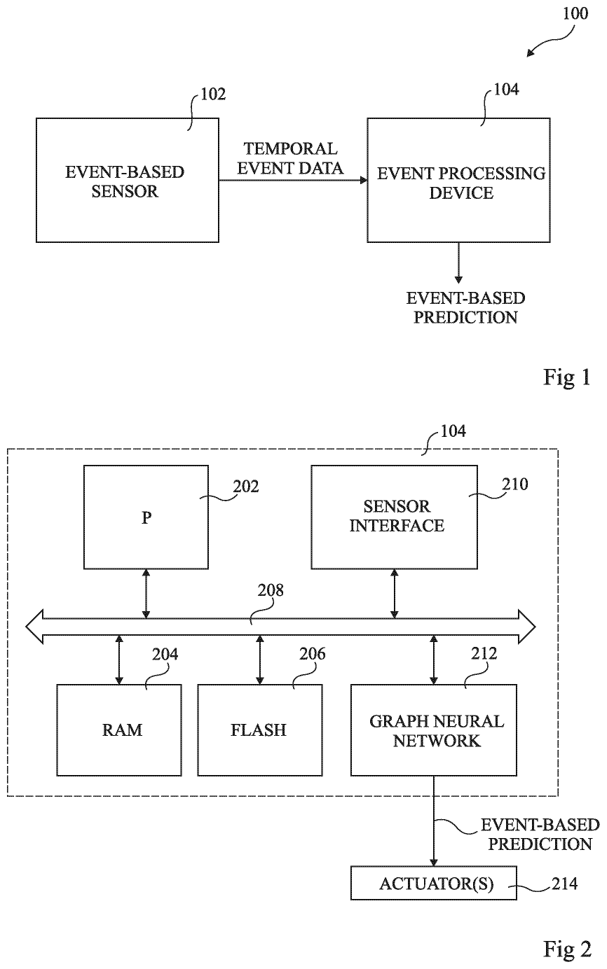

FIG. 1 schematically illustrates an event-based sensing and processing system 100 according to an example embodiment of the present disclosure. The system 100 comprises an event-based sensor (EVENT-BASED SENSOR) 102 configured to generate temporal event data (TEMPORAL EVENT DATA), and an event processing device (EVENT PROCESSING DEVICE) 104 configured to receive the temporal event data and to process it in order to generate an event-based prediction (EVENT-BASED PREDICTION).

For example, the event-based sensor 102 is an event-based camera, or event-camera, such as a visible light, or infrared event-camera. Alternatively, the event-based sensor could be an event-based audio sensor, such as an event-based microphone. Other types of event-based sensor would also be possible.

The temporal event data for example comprises asynchronous events, each event for example comprising a time stamp and an event data value having one or more dimensions. For example, in the case that the event-based sensor 102 is a camera, the event data value could be the x and y address of the pixel that captured the event, and the event is, for example, generated upon a light-level change exceeding a threshold relative to the light-level when the previous event at the pixel was generated. Additionally, a detected light level of the pixel could provide a further dimension of the event data value, for example the polarity of the change or the absolute light-level at the moment the event was generated. In the case that the event-based sensor 102 is a microphone, events are for example generated due to relative changes in the analogue signal generated by the microphone and the features of each event may also comprise a timestamp, the absolute value of the signal and/or, if the signal is filtered into many frequency bands, the range of the frequency band of the event.

The event-based processing device 104 is for example configured to process the temporal event data in real-time or close to real-time, for example with a processing delay of less than one hundred microseconds, and preferably less than five microseconds.

In the case that the temporal data is image data, the output event-based prediction of the event processing device 104 is for example an optical flow prediction per generated event, or an object classification for the entire event stream, or an object detection per event. In the case that the temporal data is audio data, the output event-based prediction of the event processing device 104 is for example a key-word spotting per a group of events or a sound class recognition.

FIG. 2 schematically illustrates the event processing device 104 of FIG. 1 in more detail according to an example embodiment of the present disclosure.

The device 104 for example comprises a processing device (P) 202 comprising one or more processors, and one or more memory devices, such as a volatile memory (RAM) 204 and/or a non-volatile memory (FLASH) 206. In some embodiments, the volatile memory 204 is a random-access memory, and/or the non-volatile memory 206 is a Flash memory, although other types of volatile and non-volatile memories could be present.

The processing device 202 and memories 204, 206 are for example linked by a bus 208. The non-volatile memory 206 for example stores software code, which is executed by the processing device 202.

The event processing device 104 further comprises, for example, a sensor interface (SENSOR INTERFACE) 210 coupled to the bus 208, the sensor interface 210 for example being configured to communicate with the event-based sensor 102 over a wired or wireless communications interface.

In some embodiments, the event processing device 104 further comprises a graph neural network (GRAPH NEURAL NETWORK) 212, which is also for example linked to the bus 208, and is configured to generate the event-based prediction (EVENT-BASED PREDICTION) at an output of the event processing device 104. For example, while not illustrated in FIG. 2, the event-based prediction is provided by the graph neural network to an output interface of the device 104 coupled to the bus 208.

The graph neural network 212 is for example a hardware circuit configured to implement a method of generating a prediction based on event data captured by the event-based sensor 102 described in more detail herein. In alternative embodiments, the graph neural network is implemented in software, and the method of generating a prediction based on event data captured by the event-based sensor 102 is implemented by software stored in the memory 204 or 206 and executed by the processing device 202. Alternatively, the processor reads data from the event-based sensor, processes this data and then supplies this data to the graph neural network in the appropriate format to perform event-based prediction.

In some embodiments, the event-based prediction generated by the graph neural network 212 is used to control one or more actuators (ACTUATOR(S)) 214 coupled to the device 104. The one or more actuators 214 for example comprise a robotic system, such as a robotic arm trained to pull up weeds, or to pick ripe fruit from a tree, an automatic steering or breaking systems in a vehicle, or an electronic actuator, which is for example configured to control the operation of one or more circuits, such as waking up a circuit from sleep mode, causing a circuit to enter into a sleep mode, causing a circuit to generate a text output, to perform a data encoding or decoding operation, etc. According to a further example, the device 104 is an eye tracking unit that determines the area in a scene where a user is looking and controls the actuators as a function of the determined area, for example in order to change the focus of the stereogram.

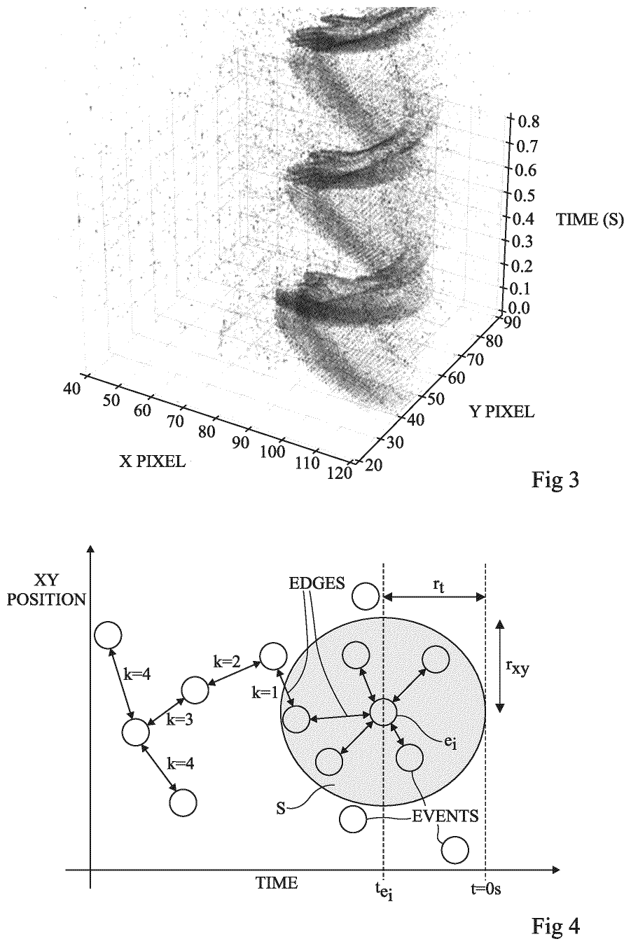

FIG. 3 is a graph illustrating an example of the event cloud generated from an event camera recording. In particular, the graph of FIG. 3 is a 3D graph representing, on an x-axis, a pixel coordinate (X PIXEL) in an x direction of a pixel array of the camera, on a y-axis, a pixel coordinate (Y PIXEL) in a y direction of the pixel array, and on a z-axis, time in seconds (TIME(s)). The spiral of the data represented in FIG. 3 results from a circular motion of a person's hand in the image.

By analyzing the 3D data structure of event data of FIG. 3, or similarly by analyzing 2D, 4D or a higher dimension data structure of event data, it is possible to perform prediction operations, such as classification in order to determine what type of object created the events, or prediction of optical flow, for example to determine the velocity vector of the object, or detection, for example is a certain object present in the scene.

FIG. 4 is a graph illustrating an example of an event graph where the number of k-hops between indirectly connected events is noted. Event graph creation involves, in particular, the generation of a tree structure, followed by a nearest neighbor search over the tree which permit edges between events (i.e., vertices) to be defined. For example, the creation of a KD-tree structure is described in more detail in the publication by Zhou, Kun et al. entitled “Real-time KD-Tree Construction on Graphics Hardware”, ACM Transactions on Graphics (TOG) 27.5 (2008):1-11. A set of events is recorded and the tree structure is created. This tree structure is used to search for a set of nearest neighbors for each event. Edges are formed between these events (i.e., nodes) based on a distance measure in the pixel dimensions (e.g. x,y) and the time dimension (t). For example, a directed edge is connected between the M nearest events within a fixed search radius.

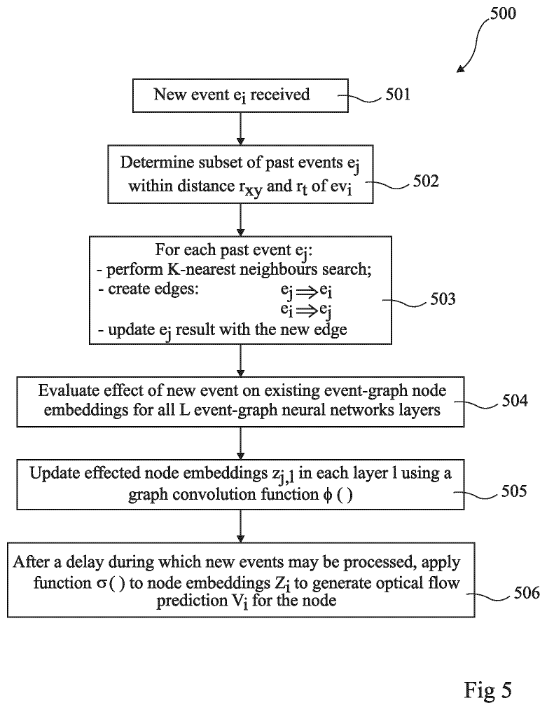

This process is illustrated in FIG. 4, which shows time (TIME) on the x axis and an x, y position (XY POSITION) of pixel data on the y axis. A new event eᵢ for a given pixel is detected by an event-based sensor at a time tₑ_{ᵢ}. Further events (EVENTS) are also represented on this graph. A search volume S(r_{xy},rₜ) is defined as being within a time distance rₜ from the time tₑ_{ᵢ} of the new event, and within a spatial distance r_{xy} from the new event, as represented by an ellipse S. Half of this search volume S is prior to the time of the new event tₑ_{ᵢ}, and the other half of the search volume S is later than the arrival time of the new event tₑ_{ᵢ}. Thus, as illustrated in FIG. 4, the search volume comprises events within a radius of the new event eᵢ. Among the events falling within the search volume, the K-nearest neighbors are connected to the new event eᵢ by edges. These edges may be inherently bi-directional or uni-directional, although often two uni-directional edges will form between pairs of events with such a Euclidean based search paradigm. Furthermore, importantly, as new events are generated, the edge configurations of existing events in the tree are also updated in the case that the new events eᵢ become one of the closest neighbors of the existing events. As will be explained in more detail below in relation with FIG. 5, the event graph is then updated in view of the new event eᵢ and the new edges. In particular, the effect of the new event eᵢ on existing event-graph node embeddings are evaluated for all L event-graph neural network layers and potentially a large number of times. Depending on the node embedding update method, this may be very computationally costly and incur significantly latency. To avoid updating the node embeddings of the entire active event-graph each time a new event is generated, a recursive k-hop graph search function hop( ) may for example be applied in order to find the sparse subset of nodes impacted in each of the L layers. Only this subset of nodes will be updated upon the arrival of each new event, which may slightly ease the computational burden. As illustrated in FIG. 4, the direct connections with the new event eᵢ are connected by a single hop, corresponding to k=0, and an integer number K of further hops is determined through intermediately connected nodes. In the example FIG. 4, K=4 between the central event eᵢ and the event in the upper left-most corner of the diagram.

FIG. 5 is a flow diagram illustrating an example of operations in a method of determining an optical flow prediction according to the approach illustrated by the graph of FIG. 4.

In an operation 501, a new event eᵢ received.

In an operation 502, a subset of past events eⱼ is determined within distance r_{xy} and rₜ of the event eᵢ. In other words, the past events falling within the search volume S of FIG. 4 are identified.

In an operation 503, for each past event eⱼ, a K-nearest neighbors search is performed, and edges are created. In particular, edges eⱼ⇒eᵢ are created from each past event eⱼ of the K-nearest neighbors to the new event eg. Furthermore, edges eᵢ⇒eⱼ are created from the new event eᵢ to each of the K-nearest neighbors in the past, and the node embeddings of all nodes impacted over an integer number of K-hops from event eᵢ must be updated. The event eⱼ will thereafter likely be modified several times as more new events are generated within a delay equal to the temporal search radius, which forms direct K=0 connections to future events, multiplied by the number of layers (via modifications through nodes connected by a certain number of K-hops).

In an operation 504, the effect of new event eᵢ on existing event-graph node embeddings for all L event-graph neural network layers is evaluated. This involves the recursive k-hop graph search function hop( ), which finds the sparse subset of nodes impacted in each layer l of the event graph, as represented in FIG. 4.

In an operation 505, effected node embeddings Z_{j,i} in each layer l are updated using a graph convolution function. The graph convolution function, φ( ), may be for example the spectral graph convolution proposed in the publication “SEMI-SUPERVISED CLASSIFICATION WITH GRAPH CONVOLUTIONAL NETWORKS” Kipf 2017, Zₗ=f(A′·Zₗ₋₁·Wₗ), where A′=D^{-1/2}·A·D^{-1/2}, A is the adjacency matrix that stores the 0 or 1 in each matrix cell denoting whether nodes are connected and D is the degree matrix.

In an operation 506, after a delay equal to the radius rₜ of the search window multiplied by the number of graph neural network layers, during which time further new events that impact the event eᵢ may be received and processed, a function σ( ) is applied to the node embeddings Zᵢ to generate an output prediction Vᵢ, for example an optical flow prediction, in relation with the new event eᵢ.

The method of FIG. 5 can for example be represented by the following algorithm.

[Math 1]
Algorithm 1 Sparse fully-spherical update

```
Input : evᵢ = {xᵢ, yᵢ, tᵢ, pᵢ}, G = {EV, ε}, rₜ, r_{xy}
Output : Vᵢ
M = EV ∩ B(evᵢ, r_{xy}, rₜ)
for evₘ ∈ M do
  εₘ = knn(evₘ, EV, rₜ, r_{xy})
end for
G = π(G, εₘ, evᵢ)
for l in range(L) do
  for evⱼ ∈ hop(M, G, l) do
    z_{j,l} = φ(evⱼ, G, l)
  end for
end for
if t > tᵢ + (rₜ × L) then
  Vᵢ = σ(Zᵢ)
end if
```

where evᵢ is the new event, xᵢ, yᵢ are data values of the event data value, tᵢ is the time stamp of the event, pᵢ is the event polarity, G is the event-graph, EV is a subset equal to {x, y, t}∈ [symbol] ³, ε are the edges of the event-graph connecting the events EV, [symbol] ( ) is a function used to extract the subset of operation 502 above, knn( ) is the K-nearest neighbor search, π( ) is a function that takes as an input the previous graph state, the new event, and new and recalculated edges εₘ and returns an updated event graph, hop( ) is the recursive k-hop graph search function, and z_{j,l} are the node embeddings in a given layer l.

A major drawback of the method of FIG. 5 is that it results an excessive number of calculations and in a relatively high latency between the time of the new event arriving, and the outputting of the prediction. This is due in part to the complexity of the processing, and also to the graph building latency, comprising the delay rₜ*L, which is typically of several hundred milliseconds.

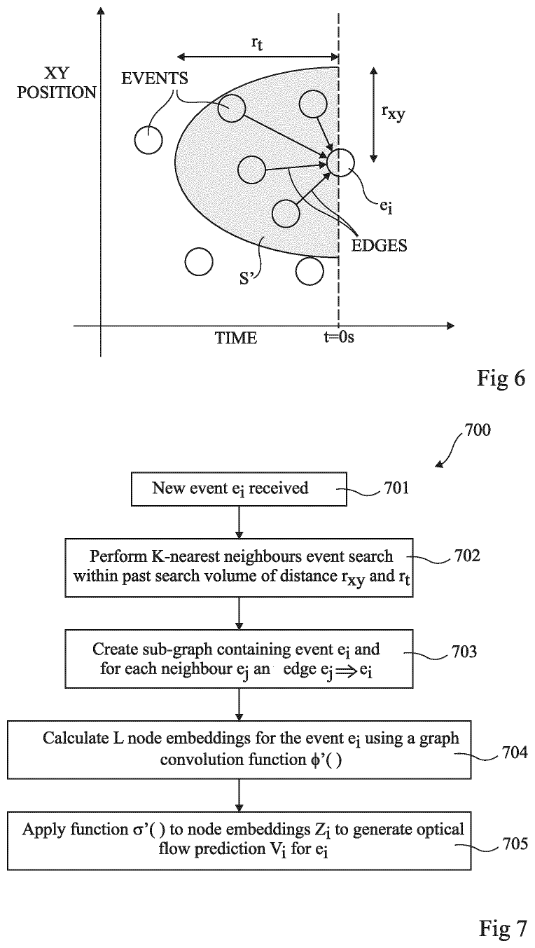

FIG. 6 is a graph illustrating an example of event graph creation according to an example embodiment of the present disclosure. The graph of FIG. 6 is similar to that of FIG. 4, except that the search volume S is modified to a search volume S′, and the edges (EDGES) between past events (EVENTS) and the new event eᵢ are strictly unidirectional, as will now be explained in more detail. In particular, the edges connect outputs of the nodes representing past events within the search volume S′ to inputs of the node corresponding to the new event eᵢ.

According to the embodiment represented by FIG. 6, the graph building latency is reduced by limiting the creation of edges in event-graphs such that directed unidirectional edges are formed only from past events to a newly arrived event within a hemi-spherical or hemi-elliptical search radius S′ around the newly arrived event. In other words, when a new event arrives, only the past vicinity is searched for events that it will connect to and get data from. The edges towards the past events, that were created according to the previous method, are no longer created, and therefore the edges are unidirectional in time, from past to future, as represented in FIG. 6 by arrows only pointing forwards in time, i.e. to/towards the future. This enables a prediction to be computed for an event immediately for a generated event. Indeed, it can be guaranteed that neither this event's node embeddings, nor its edges, will change in the future. This greatly reduces the latency as well as the amount of calculation.

In the case of a graph neural network, these edges are used to immediately calculate the node embeddings of only the newly generated event for each layer of the network. Past events now never change their embedding once calculated. This is in contrast to previous approaches whereby a large number of past events are required to be recalculated upon the arrival of each event. Only the embedding from the past events within a certain time and space search radius to which it is connected are used in this process.

According to the approach of FIG. 6, the edges, i.e., the identities of the two events linked by the edge as well as any edge properties such as temporal difference, are for example not explicitly stored in memory since the information pertaining to these edges is implicitly represented by the node embeddings of previously generated events. Thus, this approach permits memory storage to economized, such as the memory 204 and/or 206 of FIG. 2, which can be significantly smaller. In addition, the past events falling outside of the time search radius are not for example stored. This is in contrast to the previous approaches in which events within a temporal window equal to the search radius multiplied by the number of neural network layers are stored, and all edges linking these events are also stored.

The above factors allow for an implementation with a significantly reduced memory footprint relative to other approaches. Specifically, a real-time implementation of the embodiments described herein for example incorporate a functionality wherein the memory of the system on which the algorithm is embedded is continually cleaned such that events older than a certain time are removed.

In some embodiments, in order to maintain a number of detected events that is relatively similar to the approach of FIG. 4, the radius rₜ is for example increased with respect to a typical value used according to that approach. Typically, this is achieved by increasing, for example approximately doubling, the radius rₜ such that the search volumes are equivalent. For example, the radius rₜ in the case of FIG. 4 is for example of between 10 and 20 ms, and the radius rₜ in the case of FIG. 6 is for example of between 20 and 40 ms.

FIG. 7 is a flow diagram for an example of operations in a method of determining an optical flow prediction according to an embodiment of the present disclosure. This method could equally be used to determine other types of predictions, such as a classification or object detection. In the case of classification, where an event-by-event output may not be required, the node embedding of all events generated within certain temporal window may be aggregated, for example using max or mean pooling, and it is this aggregated node embedding that is, for example, periodically given to the output prediction function.

The method of FIG. 7 is for example implemented by the event processing device 104 of FIG. 1.

In an operation 701, a new event eᵢ received by the event processing device 104, for example from the event-based sensor 102.

In an operation 702, a K-nearest neighbors event search is for example performed within a past search volume of radius r_{xy} in the one or more dimensions of the event data value, and of radius rₜ in the time domain. For example, this is achieved by performing a distance measurement between the new event and the past events, the distance calculation for example being based on the L2 norm. It would also be possible to use other distance metrics such as the L1 norm or simply the max distance function, corresponding to using the maximum of all dimensions (such as the maximum of all three dimensions in the case that there are three).

In an operation 703, a sub-graph is created containing the new event eᵢ and, for each neighbor eⱼ among the K-nearest neighbors, a unidirectional edge eⱼ⇒eᵢ. In some embodiments, unidirectional edges are created from each of the neighbors eⱼ to the new event eᵢ. In other embodiments, unidirectional edges are created from a selection of M events among the events eⱼ, where M is for example equal to at least two, and for example to between 2 and 50, and preferably around 30. For example, in some embodiments, this selection of M events corresponds to the M closest neighbors of the new event eg. In alternative embodiments, the M events could be selection based on another approach, such as by randomly selecting M past events within the search volume, or selecting the M furthest past events within the search volume.

In an operation 704, L node embeddings are calculated for the event eᵢ using a graph convolution function φ′( ). This function φ′( ) is for example the same as the function φ( ), except that the input to this function is a past-only graph like the one represented in FIG. 6, and thus the edges that are used for the calculation of the L node embeddings consist only of strictly unidirectional (past to present) edges.

In an operation 705, a function σ′( ) is for example applied to the node embeddings Zᵢ to generate an optical flow prediction Vᵢ for the new event eᵢ. For example, the function σ′( ) is applied by passing the sub-graph through a neural network such as the one described in relation with FIG. 6.

The method of FIG. 7 can for example be represented by the following algorithm.

[Math 2]
Algorithm 2 Hemi-spherical update

Input : evᵢ = {xᵢ, yᵢ, tᵢ, pᵢ}, EV, rₜ, r_{xy}
Output : Vᵢ
Kᵢ, εᵢ = knn(evᵢ, EV, rₜ, r_{xy})
Gᵢ = {Kᵢ, εᵢ}
for l in range(L) do
z_{i,l} = φ′(Gᵢ, l)
end for
Vᵢ = σ′(Zᵢ)

where evᵢ is the new event, xᵢ, yᵢ are data values of the event data value, tᵢ is the time stamp of the event, pᵢ is the event polarity, Kᵢ are the nearest neighbor events connected by unidirectional edges εᵢ, Gᵢ is the sub-graph, and knn( ) is the K-nearest neighbor search.

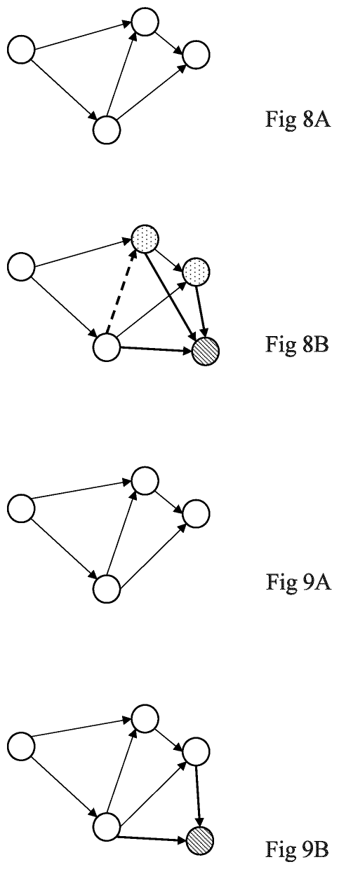

FIGS. 8A and 8B illustrate an example of updating an event graph upon arrival of a new event, based on the technique of FIGS. 4 and 5, but considering only past to future edges, that is edges pointing forwards in time, in other words to/towards the future, between events.

FIG. 8A illustrates an example of an event graph that initially comprises four events connected by unidirectional edges pointing forwards in time, in other words to/towards the future. In the example of FIG. 8A, the unidirectional edges are present at the output of each event and point towards its two closest neighboring events, in other words M is equal to 2 as regards the output edges of each event node.

FIG. 8B illustrates an example of the arrival of a new event, and thus the addition of a corresponding new event node to the event graph represented with striped lines in FIG. 8B. This involves the creation of three new edges, represented in bold, each pointing towards the new event from three respective past events. For two of the three past events highlighted with dots in FIG. 8B, there was previously a single output edge and the new edge is a second edge. Furthermore, the third past event node already had two output edges, and the previous edge represented by a dashed arrow is removed and replaced by a new edge pointing towards the new event. This provokes an update to the each of the past events highlighted with dots in FIG. 8B, due to the direct modification of its inputs (in the case of the left-hand dotted event node having an input edge that is removed) or the updating of one of its input nodes (in the case of the right-hand dotted event node).

The algorithm applied in order to process the new event in the example of FIGS. 8A and 8B can thus be described as follows:

For each new event ‘e’:
Search for all the events that could connect to it
   for each event found ‘ec’
      1. If ‘ec’ already has M output connections
         a. Compare (ec=>e) to M existing (ec=>ei) edges
         b. Determine whether to replace one of these with new (ec=>e) edge
         c. If (ec=>ei) is removed, update ‘ei’ and ‘ei’ children output for GNN
      2. Else add (ec=>e) connection
      3. Update ‘ec’ output for GNN

As represented by FIGS. 8A and 8B, a drawback of such an approach is that the arrival of the new event involves reassessing the edges defined for the past event nodes, and thus updating past event nodes, which implies heavy processing and also storing in memory the outputs and edges for each past event within a given time period for the case in which a new edge from a past event node is created. The time period during which outputs and edges of past events are stored is proportional to the number of GNN layers and the time radius of the search volume, in particular #GNN_layers*Time_radius.

FIGS. 9A and 9B illustrate an example of updating an event graph upon arrival of a new event, based on the technique of FIGS. 6 and 7.

FIG. 9A illustrates an example of an event graph that initially comprises four events connected by unidirectional edges pointing forwards in time, in other words to/towards the future. In the example of FIG. 9B, unidirectional edges are present at the input of each event and arrive from its two closest neighboring events. In other words, M is still equal to 2, but M is defined based on the number edges at the inputs to each event node rather than based on the number of edges at the outputs of each event node, as is the case for FIGS. 8A and 8B.

FIG. 9B illustrates an example of the arrival of a new event, and thus the addition of a corresponding new event node to the event graph represented with striped lines in FIG. 9B. In contrast with the example of FIG. 8B, incorporating the new event only involves creating M new edges going forward in time from the identified closest neighbors to the new event node, and these edges are then final edges that will not be modified by the arrival of new events. Furthermore, in contrast with the case of FIG. 8B, none of the past event nodes is modified in response to the arrival of the new event, because the input edges of the past event nodes are never modified.

The algorithm applied in order to process the new event in the example of FIGS. 9A and 9B can thus be described as follows:

For each new event ‘e’:
Search for M events in its past (e0, e1, . . . , em)
Make connections ((e0=>e), (e1=>e), . . . , (em=>e))
Compute ‘e’ outputs for GNN

In some embodiments, the M events in the past are M closest neighbors within the search radius, but it would also be possible to select M past events using another approach, such as by randomly selecting M past events with the search volume, or selecting the M further past events within the search volume.

An advantage of the technique applied in FIGS. 9A and 9B is that it implies a relatively light processing at the arrival time of each new event, meaning that real-time or near real-time processing is possible. Furthermore, given that previously defined input edges of past events are not updated by the arrival of new events, the number of past event outputs stored in memory can be relatively low, for example corresponding to only the outputs of past nodes falling within the search volume.

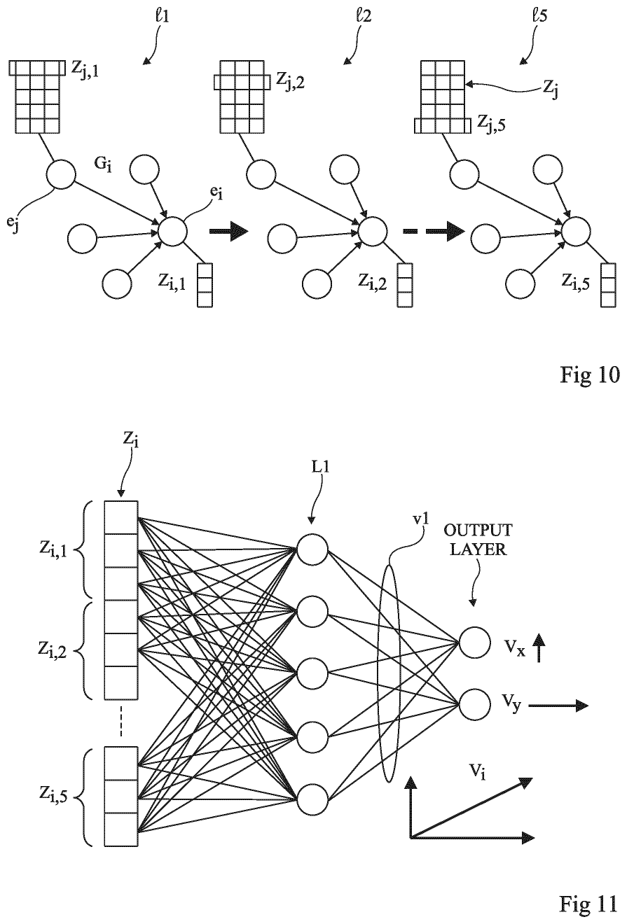

FIG. 10 illustrates the generation of an embedding vector in each layer of an event graph according to an example embodiment of the present disclosure. Notably, a graph neural network is used to calculate the node embeddings. FIG. 10 illustrates an example in which the event graph neural network, applied to the event graph Gᵢ, comprises five layers 11 to 15. In each layer, an embedding vector Z_{j,i} is calculated for an event using the embeddings of connected events. For example, FIG. 10 illustrates an example of an embedding matrix for event j Zⱼ associated with one of the connected events eⱼ of the new event eᵢ, the embedding matrix Zⱼ comprising sub-vectors Z_{j,1} to Z_{j,S} for each layer 1 to 5. The embedding vector Z_{j,1} of the first layer is for example formed of the corresponding event, comprising for example the time information in the form of a time stamp, and the event data value having one or more dimensions. In the example of FIG. 10, each embedding vector Z_{j,1} comprises three values, which may, for example, in the first layer respectively correspond to the time stamp and the pixel coordinates in X and Y and in subsequent layers corresponds to an abstract vector representation of the event. To obtain the embedding in each of these subsequent layers, in each subsequent layer, a transformation is applied to the embedded vector of each node, or to the input event data in the case of the first layer, in order to generate a resulting embedding vector Z_{i,l}. This transformation also takes into account the embeddings of other nodes to which the node is connected by an edge. For example, the transformation could be a sum or average of the embedding vectors or indeed something more complex based on the edge information. The layers of the event graph neural network are for example chained sequentially as is the case for standard neural networks.

FIG. 11 illustrates the concatenation of embedding vectors and their application to a neural network according to an example embodiment of the present disclosure. In particular, the embedding vectors Z_{i,l} of each layer of the neural network associated with the new event eᵢ are for example processed by passing them through a neural network in order to generate a prediction associated with the new event eᵢ. In the example of FIG. 11, this involves concatenating the embedding vectors Z_{i,l} to form a single vector Zᵢ, and processing this vector by a multi-layer perceptron. For example, in a first layer L1 of the multi-layer perceptron neural network, an instance normalization may be applied in order to produce a first vector representation v1 for the event. To generate the prediction Vᵢ, which is for example an optical flow prediction, this first vector representation v1 is for example processed by one or more further layers including an output layer (OUTPUT LAYER), which returns two output values Vₓ and V_{y}, which correspond for example to x and y components of the event optical flow vector Vᵢ.

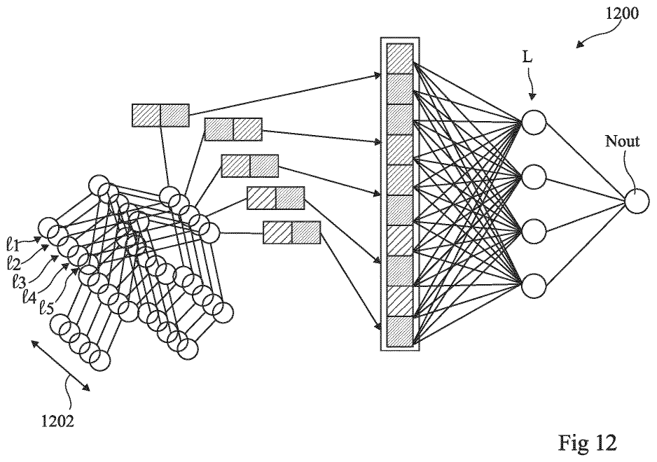

FIG. 12 schematically illustrates a neural network head 1200 for making a prediction according to an example embodiment of the present disclosure. FIG. 12 illustrates in particular an example in which there are five layers 1202, referenced 11 to 15, in the graph neural network, and the outputs state of each layer, for each node, is provided as an input of the neural network head 1200. For the layers 12 to 15, the input to each layer is the output of the previous layer, while applying, for example, new weights and message passing parameters. For example, in each layer, the same shared weight is applied to all nodes. The weight is different for each layer. Message passing depends on the type of convolution. For many types of convolution there are no parameters. For more complex types, like B-spline conv, there are for example the number of basic functions/kernels to set as a parameter that could change from layer to layer.

The neural network head 1200 for example comprises, in the example of FIG. 12, a layer L of four neurons receiving a concatenation of the node embeddings of a given node of each of the layers 11 to 15 of the graph neural network. For example, the neurons of the layer L are configured to apply a rectifying linear activation function. Instance normalization may be applied to the activations of this layer. The outputs of the neurons of the layer L are for example supplied to a single output neuron Nout, which is for example configured to generate a prediction corresponding, for example, to a probability of between 0 and 1.

An advantage of the graph creation algorithm described herein is that it allows for a drastically lower latency, typically by around four orders of magnitude, and a lower total computation burden, for example by two orders of magnitude, with respect to prior approaches. Furthermore, the edges are for example no longer stored in memory, and events that are older than a time equal to the temporal search radius are for example removed from memory.

Various embodiments and variants have been described. Those skilled in the art will understand that certain features of these embodiments can be combined and other variants will readily occur to those skilled in the art.

For example, in the case of a graph neural network, pooling operations may be used to coarsen the graph, thereby reducing the number of nodes and also the amount of required computation. For example, a pooling operation is trigged periodically for given graph neural network layers using, for example, a given voxel grid size, i.e., a periodic grid in the spatial (xy) and time (t) dimensions of the input event cloud. Events within a single voxel for example have their features aggregated into a single super-event and the connections between these super-events are for example based on either preserving connections between voxels that previously existed or by performing a new search, in the past only, and defining a new set of edges.

Furthermore, while embodiments have primarily been described in the context of camera data, that is event data values in two dimensions, x and y, the techniques described here would be applicable to other types of event-based sensors, such as an event-based cochlea, or silicon ear. In such a case, rather than encoding events in space and time, the silicon ear for example encodes events in frequency band energy and time—resulting in 2D point plane instead of a 3D point cloud in the case of event-cameras. For example, such a silicon ear is described in more detail in the publication by Chan, Vincent, Shih-Chii Liu, and Andr van Schaik. “AER EAR: A matched silicon cochlea pair with address event representation interface.” IEEE Transactions on Circuits and Systems I: Regular Papers 54.1 (2007): 48-59. Additionally, the embodiments described herein could be applied to any application with a temporal or causal dimension. For example, they could be applied to data structures that can be gradually explored, with the possible limitation that no loop is created (translation of the condition “edges only connect past to future”, means the obtained graph with one-way edges has no loops).

Furthermore, any operation can be applied to the data before and/or after the proposed graph construction. For instance, data filtering could be applied, whereby an event at a given pixel of the same polarity emitted within a certain time window will be discarded before processing. Other options are the normalization of input features and the encoding of time using a single or a pair of periodic functions, such as a sawtooth wave, instead of the absolute time that could impose a certain memory burden.

Furthermore, the distance between nodes can be computed with any distance metric—L2 norm, L1 norm, also known as the Manhattan distance, Euclidean distance, etc.

Furthermore, the features contained in each node can for example be changed. Some of the possibilities that can be used are time, x and y coordinates of the event, approximated normalized vector to local event plane (see the publication by Mitrokhin, Anton, et al. “Learning visual motion segmentation using event surfaces.” Proceedings of the IEEE/CVF Conference on Computer Vision and Pattern Recognition. 2020), polarity of the event etc.

Node embedding normalization schemes can be used to normalize the node features in intermediate graph neural network layers. Of particular interest is the use of instance normalization since this is a technique using only node level statistics rather than batch norm or layer norm, which require grouping statistics from multiple nodes or even multiple graphs.

The features stored in the created edges can also be changed. For example, a simple binary flag can be used to indicate a connection, or, the differences in the spatial and temporal coordinates between connected events, which has been found to be particularly performant.

Search radii can be changed, statically, in other words in the same way for all graphs, or dynamically, for example according to some rule. For example, for a high density of events in time, which suggests a fast-moving edge, in a certain region of the scene, the search radius could be reduced in order to preserve spatial relationships between events generated by an object regardless of its speed. Otherwise, the approximated normal vector of an event can be used to adapt the search radius—a larger vector in given dimensions can be used to decrease the search radius since it also implies a fast-moving object. Conversely for a small valued normal vector the search radius could be enlarged.

In some embodiments, the number of neighbors can be limited, can be fixed or dynamic, or can be unlimited.

The processing undertaken is not necessarily a graph neural network, as discussed in the publication entitled “Graph Convolutional Neural Network (GCN), with the gconv and spline layers”, available at https://pytorch-geometric.readthedocs.io/en/latest/modules/nn.html. For example, processing schemes that are not AI based can be applied, including graph search algorithms.

Finally, the practical implementation of the embodiments and variants described herein is within the capabilities of those skilled in the art based on the functional description provided hereinabove.

1. A method of generating, by a data processing device (104), a prediction based on event data captured by an event-based sensor (102), the method comprising:
receiving, by the data processing device (104), a new event (eᵢ) from the event-based sensor (102), the new event comprising a time stamp and an event data value having one or more dimensions;
determining, by the data processing device (104) within a list of past events, those past events (eⱼ) falling within a time distance (rₜ) with respect to the time stamp and within a data value distance (r_{xy}) of the event data value;
constructing, by the data processing device (104), an event sub-graph comprising a first node representing the new event (eᵢ), further nodes representing each of the determined past events (eⱼ), and unidirectional edges linking each further node to the first node;
calculating, by the data processing device (104), node embeddings (Zᵢ) for the first node based on edges consisting only of said unidirectional edges linking each further node to the first node; and
generating the prediction (Vᵢ) by applying a function (σ′( )) to the node embeddings (Zᵢ).

2. The method of claim 1, further comprising controlling one or more actuators (214) based on the prediction (Vᵢ).

3. The method of claim 1, wherein constructing unidirectional edges linking each further node to the first node comprises constructing unidirectional edges pointing towards the future linking each further node to a corresponding input of the first node.

4. The method of claim 1, wherein determining the past events (eⱼ) further comprises selecting only M past events to form the determined past events, wherein M is an integer equal to at least two, and constructing the event sub-graph comprises creating only M unidirectional edges linking each further node to the first node.

5. The method of claim 1, wherein determining the past events (eⱼ) comprises performing a K-nearest neighbors event search within a past search volume having an event data value radius (r_{xy}) in the one or more dimensions of the event data value, and a time radius (rₜ) in the time domain.

6. The method of claim 1, wherein the event-based sensor (102) is an event-camera, and wherein the prediction (Vᵢ) is an optical flow prediction.

7. The method of claim 1, wherein the data processing device (104) is configured to perform real-time processing of the new event (eᵢ), the data processing device for example being configured to generate the prediction (Vᵢ) within a processing delay of less than 100 microseconds, and preferably of less than 5 microseconds, following a time of the new event (eᵢ).

8. The method of claim 1, wherein generating the prediction (Vᵢ) comprises passing the event sub-graph through a graph neural network (212).

9. The method of claim 8, wherein the graph neural network (212) comprises a plurality of layers, and passing the event sub-graph through the graph neural network (212) comprises:
calculating an embedding vector (Z_{j,i}) for the first node and for the further nodes of the sub-graph using the embeddings of all events connected by said unidirectional edges, the embedding vector (Zⱼ) comprising a sub-vector (Z_{j,1} to Z_{j,s}) for each of said layers; and
applying a transformation to the embedding vector (Z_{j,l}) of each node, or to the input event data in the case of a first layer of the graph neural network, in order to generate a resulting embedding vector (Z_{i,l}).

10. A data processing device for generating a prediction based on event data captured by an event-based sensor (102), the data processing device being configured to:
receive a new event (eᵢ) from the event-based sensor (102), the new event comprising a time stamp and an event data value having one or more dimensions;
determine, within a list of past events, those past events (eⱼ) falling within a time distance (rₜ) with respect to the time stamp and within a data value distance (r_{xy}) of the event data value;
construct an event sub-graph comprising a first node representing the new event (eᵢ), further nodes representing each of the determined past events (eⱼ), and unidirectional edges linking each further node to the first node;
calculate node embeddings (Zᵢ) for the first node based on edges consisting only of said unidirectional edges linking each further node to the first node; and
generate the prediction (Vᵢ) by applying a function (σ′( )) to the node embeddings (Zᵢ).

11. The data processing device of claim 10, further configured to control one or more actuators (214) based on the prediction (Vᵢ).

12. The data processing device of claim 10, wherein constructing unidirectional edges linking each further node to the first node comprises constructing unidirectional edges pointing towards the future linking each further node to a corresponding input of the first node.

13. The data processing device of claim 10, wherein determining the past events (eⱼ) further comprises selecting only M past events to form the determined past events, wherein M is an integer equal to at least two, and constructing the event sub-graph comprises creating only M unidirectional edges linking each further node to the first node.

14. The data processing device of claim 10, configured to determine said past events (eⱼ) by performing a K-nearest neighbors event search within a past search volume having an event data value radius (r_{xy}) in the one or more dimensions of the event data value, and a time radius (rₜ) in the time domain.

15. The data processing device of claim 10, wherein the event-based sensor (102) is an event-camera, and wherein the prediction (Vᵢ) is an optical flow prediction.

16. The data processing device of claim 10, wherein the data processing device (104) is configured to perform real-time processing of the new event (eᵢ), the data processing device for example being configured to generate the prediction (Vᵢ) within a processing delay of less than 100 microseconds, and preferably of less than five microseconds, following a time of the new event (eᵢ).

17. The data processing device of claim 10, configured to generate the prediction (Vᵢ) by passing the event sub-graph through a graph neural network (212).

18. The data processing device of claim 17, wherein the graph neural network (212) comprises a plurality of layers, and passing the event sub-graph through the graph neural network (212) comprises:
calculating, by the graph neural network (212), an embedding vector (Z_{j,i}) for the first node and for the further nodes of the sub-graph using the embeddings of all events connected by said unidirectional edges, the embedding vector (Zⱼ) comprising a sub-vector (Z_{j,1} to Z_{j,5}) for each of said layers; and
applying, by the graph neural network (212), a transformation to the embedding vector (Z_{j,l}) of each node, or to the input event data in the case of a first layer of the graph neural network, in order to generate a resulting embedding vector (Z_{i,l}).

19. A control system comprising:
the data processing device of claim 11;
an event-based sensor (102) coupled to the data processing device and configured to generate the new event (eᵢ) and to transmit the new event to the data processing device; and
the one or more actuators (214).
